(19) United States
(12) Patent Application Publication
(10) Pub. No.: US 2023/0382241 A1
(43) Pub. Date: Nov. 30, 2023

(54) ELECTRIFIED VEHICLE AND CONTROL METHOD OF ELECTRIFIED VEHICLE

(71) Applicant: TOYOTA JIDOSHA KABUSHIKI KAISHA, Aichi-ken (JP)

(72) Inventors: Yoshihiro IKUSHIMA, Okazaki-shi (JP); Yusei NAKAMURA, Toyota-shi (JP); Rikako ZENIBANA, Toyota-shi (JP)

(21) Appl. No.: 18/295,849

(22) Filed: Apr. 5, 2023

(30) Foreign Application Priority Data
May 30, 2022 (JP) 2022-087549

(51) Int. Cl. B60L 15/20; F16H 3/18

(52) U.S. Cl. CPC B60L 15/2045; F16H 3/18; F16H 2200/0034; F16H 2200/0086; B60L 2240/486

(57) ABSTRACT

Provided is an electrified vehicle including a motor and a transmission, and a control method thereof. The electrified vehicle is caused to travel forward when forward gear is achieved and the electrified vehicle is caused to travel backward when reverse gear is achieved while the motor is performing forward rotation. When the transmission is switched to reverse gear while the electrified vehicle is traveling forward, or when the transmission is switched to forward gear while the electrified vehicle is traveling backward, fail-safe control to allow reverse rotation of the motor is executed, thereby suppressing a great shock from being generated in the vehicle.

### CROSS-REFERENCE TO RELATED APPLICATION

This application claims priority to Japanese Patent Application No. 2022-087549 filed on May 30, 2022, incorporated herein by reference in its entirety.

### BACKGROUND

### 1. Technical Field

The present disclosure relates to an electrified vehicle and a control method of the electrified vehicle.

### 2. Description of Related Art

Japanese Unexamined Patent Application Publication No. 2014-183610 (JP 2014-183610 A) discloses a battery electric vehicle of which drive wheels are driven by output of a motor, in which, when a range position of a shift lever is in the drive (D) range, forward rotation of the motor is performed and the vehicle travels forward, and when the range position is in the reverse (R) range, reverse rotation of the motor is performed and the vehicle travels backward.

### SUMMARY

The battery electric vehicle disclosed in JP 2014-183610 A does not have a transmission, but there are arrangements in which the output of the motor is transmitted to the drive wheels via a transmission in order to extend the cruising distance by driving the motor in an efficient region, or to improve traveling performance by increasing driving torque of the drive wheels. There are transmissions provided with forward gear and reverse gear as gear stages. Reverse gear is used when the vehicle is traveling in reverse (backward), and the direction of rotation of an output shaft of the transmission is reverse from that of forward gear. Hereinafter, a transmission provided with forward gear and reverse gear will also be referred to as “transmission with reverse gear”.

When traveling in reverse in an electrified vehicle that transmits output of a motor to drive wheels via a transmission with reverse gear, the gear stage is preferably switched to reverse gear by operating a shift lever to travel backward. In such an electrified vehicle, when traveling, the motor rotates in a direction by which the vehicle travels forward when the gear stage is in forward gear. In the present disclosure, the rotation of the motor in the direction by which the vehicle travels forward when the gear stage is forward gear will be referred to as “forward rotation”, and the direction of this rotation will be referred to as “forward rotation direction”.

In this way, in an electrified vehicle equipped with a transmission with reverse gear, the motor is controlled to perform forward rotation, and the vehicle travels forward and backward by switching gear stages of the transmission. Accordingly, when the shift lever is operated while the vehicle is traveling forward and the gear stage is switched from forward gear to reverse gear, the drive wheels are driven in the backward direction by the motor performing forward rotation, resulting in a great shock being generated in the vehicle. In the same way, when the shift lever is operated while the vehicle is traveling backward and the gear stage is switched from reverse gear to forward gear, the drive wheels are driven in the forward direction by the motor performing forward rotation, resulting in a great shock being generated in the vehicle.

The present disclosure provides an electrified vehicle equipped with a transmission with reverse gear that suppresses a great shock from being generated in the vehicle, even when switching the gear stage to reverse gear while traveling forward or switching the gear stage to forward gear while traveling backward.

A first aspect of the present disclosure relates to an electrified vehicle including a motor, a transmission that includes a forward gear and a reverse gear and that is configured to transmit output of the motor to drive wheels, and an electronic control unit. The electronic control unit is configured to cause the electrified vehicle to travel forward when forward gear is achieved, and to cause the electrified vehicle to travel backward when reverse gear is achieved while the motor is performing forward rotation. The electronic control unit is configured to, when the electrified vehicle is traveling, control the motor to perform forward rotation, and to allow reverse rotation in which the motor rotates in an opposite direction from the forward rotation, when the transmission is switched to the reverse gear while the electrified vehicle is traveling forward, and is configured to allow the reverse rotation of the motor when the transmission is switched to the forward gear while the electrified vehicle is traveling backward.

A second aspect of the present disclosure relates to a control method of an electrified vehicle including a motor and a transmission that includes a forward gear and a reverse gear and that is configured to transmit output of the motor to drive wheels. The control method (i) causes the electrified vehicle to travel forward when the forward gear is achieved and causes the electrified vehicle to travel backward when the reverse gear is achieved, while the motor is performing forward rotation, (ii) controls the motor to perform forward rotation when the electrified vehicle is traveling, and (iii) allows reverse rotation in which the motor rotates in an opposite direction from the forward rotation, when the transmission is switched to the reverse gear while the electrified vehicle is traveling forward, and allows the reverse rotation of the motor when the transmission is switched to the forward gear while the electrified vehicle is traveling backward.

According to the electrified vehicle of the first aspect and the control method of the electrified vehicle of the second aspect, the motor is controlled to perform forward rotation when the electrified vehicle is traveling. The electrified vehicle travels forward when forward gear of the transmission is achieved, and travels backward when reverse gear is achieved. Forward/reverse traveling of the electrified vehicle is performed by operating the gear stage of the transmission. When the electrified vehicle is traveling forward and the transmission is switched to reverse gear, reverse rotation of the motor is allowed. When the electrified vehicle is traveling backward and the transmission is switched to forward gear, reverse rotation of the motor is allowed. Reverse rotation of the motor means rotation of the motor in a direction opposite to forward rotation.

When the transmission is switched to reverse gear while the electrified vehicle is traveling forward, reverse rotation of the motor is allowed, and accordingly the drive wheels can be suppressed from being driven in the backward direction, and a great shock can be suppressed from being generated in the vehicle. When the transmission is switched to forward gear while the electrified vehicle is traveling backward, reverse rotation of the motor is allowed, and accordingly the drive wheels can be suppressed from being driven in the forward direction, and a great shock can be suppressed from being generated in the vehicle.

In the electrified vehicle of the first aspect described above, the electronic control unit is configured to allow reverse rotation of the motor until the electrified vehicle comes to a stop.

According to the electrified vehicle of this configuration, when the transmission is switched to reverse gear while the electrified vehicle is traveling forward, or when the transmission is switched to forward gear while the electrified vehicle is traveling backward, the motor is allowed to perform reverse rotation until the electrified vehicle comes to a stop. When the electrified vehicle comes to a stop, the motor is controlled to forward rotation, and the electrified vehicle can travel in accordance with the gear stage of the transmission.

In the electrified vehicle of the first aspect described above, the electronic control unit may be configured to perform control so that torque is output from the motor in the direction of reverse rotation when allowing the reverse rotation of the motor.

According to the electrified vehicle of the above configuration, when the transmission is switched to reverse gear while the electrified vehicle is traveling forward, or when the transmission is switched to forward gear while the electrified vehicle is traveling backward, the motor outputs torque in the reverse rotation direction, and accordingly, this torque can cancel out the inertial force in the forward rotation direction of the motor, and a great shock can be suppressed from being generated in the vehicle more suitably.

In the electrified vehicle of the first aspect described above, the electronic control unit may be configured to allow reverse rotation of the motor by setting output torque of the motor to zero.

According to the electrified vehicle of the above configuration, when the transmission is switched to reverse gear while the electrified vehicle is traveling forward, or when the transmission is switched to forward gear while the electrified vehicle is traveling backward, the output torque of the motor is set to zero, and reverse rotation of the motor is allowed, which enables a great shock to be suppressed from being generated in the vehicle, and to decelerate the vehicle toward a stop.

According to the electrified vehicle and the control method thereof according to the present disclosure, even when switching the transmission to reverse gear while traveling forward or switching the transmission to forward gear while traveling backward, a large shock can be suppressed from being generated in the electrified vehicle.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram illustrating an overall configuration of an electrified vehicle according to an embodiment of the disclosure;

FIG. 2 is a diagram illustrating functional blocks configured in an electronic control unit illustrated in FIG. 1, in the embodiment;

FIG. 3 is a flowchart showing an example of processing executed by the electronic control unit in the embodiment;

FIG. 4 is a flowchart showing an example of processing for fail-safe control, executed by the electronic control unit;

FIG. 5 is a map for calculating a reverse torque Tqr used in the processing for fail-safe control, shown in the flowchart in FIG. 4;

FIG. 6 is a flowchart showing an example of processing for fail-safe control, executed by the electronic control unit in a first modification of the embodiment; and

FIG. 7 is a map for calculating reverse torque Tqr in a second modification of the embodiment.

### DETAILED DESCRIPTION OF EMBODIMENTS

An embodiment of the present disclosure will be described in detail below with reference to the drawings. Note that same or equivalent parts are denoted by the same signs throughout the drawings, and description thereof will not be repeated.

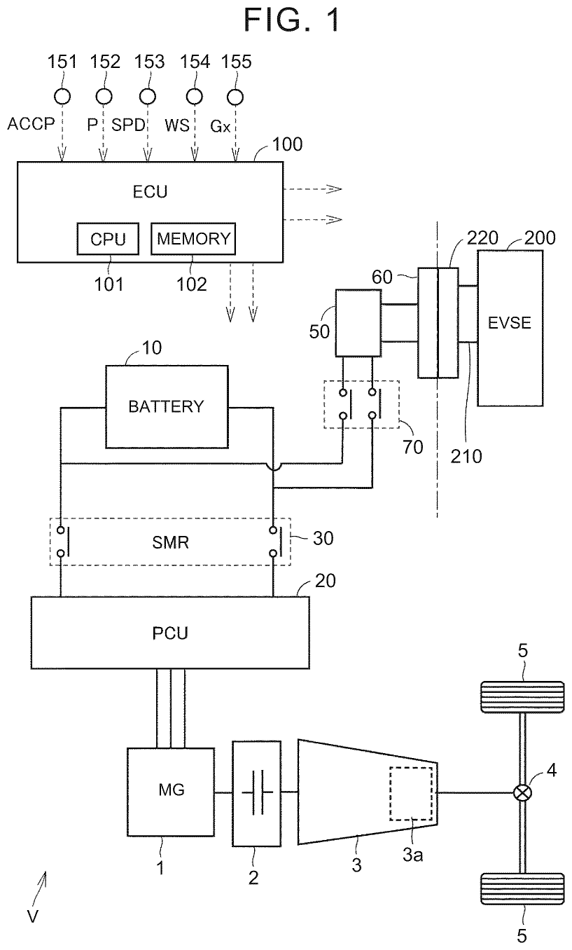

FIG. 1 is a diagram illustrating an overall configuration of an electrified vehicle according to the present embodiment. The electrified vehicle V includes a motor-generator (MG) 1, a clutch 2, a transmission 3, a differential gear train 4, and drive wheels 5.

The MG 1 is a rotating electrical machine, for example, an interior permanent magnet (IPM) synchronous motor in which permanent magnets are embedded in a rotor, and is an example of the “motor” according to the present disclosure. An output shaft (rotor shaft) of the MG 1 is connected to the clutch 2. When the clutch 2 is engaged, output torque of the MG 1 is input to the transmission 3.

The transmission 3 is a constant-mesh manual transmission, and may be, for example, a five-speed manual transmission. The transmission 3 includes forward gear and reverse gear 3a as gear stages. When reverse gear 3a is selected by a shift lever that is omitted from illustration, the rotation direction of an output shaft of the transmission 3 is the opposite direction to the rotation direction when in forward gear.

The transmission 3 may be a multi-stage automatic transmission or may be a continuously variable transmission. In this case, the output torque of the MG 1 is input to the transmission 3 via a torque converter instead of the clutch 2. When the transmission 3 is a planetary gear type multi-stage automatic transmission, reverse gear 3a is achieved by controlling the engagement state of friction engagement devices (clutches, brakes). Also, in the case of a continuously variable transmission, a forward/reverse switching device made up of planetary gears or the like corresponds to reverse gear 3a, and when the forward/reverse switching device is switched to reverse, reverse gear is achieved.

The output shaft of the transmission 3 is connected to the differential gear train 4 via a propeller shaft. The differential gear train 4 is connected to the drive wheels 5 via a drive shaft. The electrified vehicle V transmits the output torque (driving torque) output from the MG 1 to the drive wheels 5 via the transmission 3 and the differential gear train 4.

A power control unit (PCU) 20 is an electric power conversion device that bidirectionally converts electric power between the MG 1 and a battery 10. The PCU 20 includes, for example, an inverter and a converter. The converter boosts voltage supplied from the battery 10, and supplies the boosted voltage to the inverter. The inverter converts direct current electric power supplied from the converter into alternating current electric power, to drive the MG 1.

The battery 10 is a rechargeable secondary battery, and is a battery pack in which a plurality of single cells (battery cells) is stacked. For example, the single cells are electrically connected in series to make up the battery pack. The single cells may each be a lithium-ion battery or a nickel metal hydride battery. The battery 10 and the PCU 20 are connected via a system main relay (SMR) 30.

The battery 10 can be charged using an external electric power supply 200. The electrified vehicle V has an inlet 60 to which a connector 220 of the external electric power supply 200 can be connected. The external electric power supply 200 may be a commercial alternating current (AC) electric power supply, and alternating current electric power supplied from the external electric power supply 200 to the inlet 60 is converted to direct current electric power by a charger 50, and supplied to the battery 10 via a charging relay 70, thereby charging the battery 10. During braking of the electrified vehicle V, the battery 10 may be charged using regenerated electric power from the MG 1.

An electronic control unit (ECU) 100 controls the PCU 20, the SMR 30, the charger 50, the charging relay 70, and so forth. The ECU 100 includes a central processing unit (CPU) 101 and memory (including, e.g., read only memory (ROM), random access memory (RAM), and so forth) 102. The ECU 100 controls each device such as the PCU 20 and so forth, so that the electrified vehicle V is in a desired state, based on signals from various types of sensors, and information such as maps, programs, and so forth stored in the memory 102.

The various types of sensors of which signals are input to the ECU 100 include, for example, an accelerator operation amount sensor 151, a shift position sensor 152, a vehicle speed sensor 153, a wheel speed sensor 154, a longitudinal acceleration sensor 155, and so forth. The accelerator operation amount sensor 151 detects an accelerator operation amount ACCP, which is an amount of depression of an accelerator pedal. The shift position sensor 152 detects a position (shift position) P of the shift lever that operates the gear stage of the transmission 3. The vehicle speed sensor 153 detects vehicle speed SPD of the electrified vehicle V. The wheel speed sensor 154 detects speed (wheel speed) WS of the drive wheels 5. The longitudinal acceleration sensor 155 detects longitudinal acceleration Gx of the electrified vehicle V.

The ECU 100 performs normal control when the electrified vehicle V is traveling. In normal control, the ECU 100 calculates a target driving torque Tr based on the accelerator operation amount ACCP, the vehicle speed SPD, and so forth, and multiplies the target driving torque Tr by the wheel speed WS to obtain a target output. A command torque Tqt for the MG 1 is then calculated so that the target output is output from the MG 1. The command torque Tqt is torque in the forward rotation direction that causes the electrified vehicle V to travel in the forward direction when the gear stage of the transmission 3 is forward gear (hereinafter also referred to as “positive torque”). The ECU 100 controls the PCU 20 so that the output torque of the MG 1 achieves the command torque Tqt.

During normal control, the MG 1 rotates in the forward rotation direction (forward rotation). Accordingly, when performing reverse rotation in which the MG 1 rotates in the opposite direction as to the forward rotation during normal control, there is a high probability that the system is malfunctioning. The ECU 100 determines reverse rotation of the MG 1 using signals from a resolver of the MG 1 or a rotary encoder. When detecting reverse rotation of the MG 1 during normal control, the ECU 100 then determines that the system is malfunctioning, and issues an alarm. The alarm may be a malfunction indicator light (MIL) turning on.

In the electrified vehicle V, switching of forward/backward travel is performed by switching gear stages (forward gear and reverse gear) of the transmission 3. For example, when traveling backward to park the electrified vehicle V (back-up parking), a driver will often repeat forward/reverse traveling, in order to adjust the position of the electrified vehicle V in a parking space. When doing so, the gear stage is switched to reverse gear to travel backward, following which the gear stage is switched to forward gear to travel forward, which may be repeated several times. In this situation, when the gear stage is switched from forward gear to reverse gear while the electrified vehicle V is traveling forward, and reverse gear is achieved as the gear stage, the drive wheels 5 are driven in the backward direction by the MG 1 performing forward rotation, generating a great shock in the vehicle. Also, when the gear stage is switched from reverse gear to forward gear while the electrified vehicle V is traveling backward, and forward gear is achieved as the gear stage, the drive wheels 5 are driven in the forward direction by the MG 1 performing forward rotation, generating a great shock in the vehicle.

In the present embodiment, when reverse gear is achieved while traveling forward, or when forward gear is achieved while traveling backward, reverse rotation of the MG 1 is allowed, in order to suppress a great shock from being generated in the vehicle.

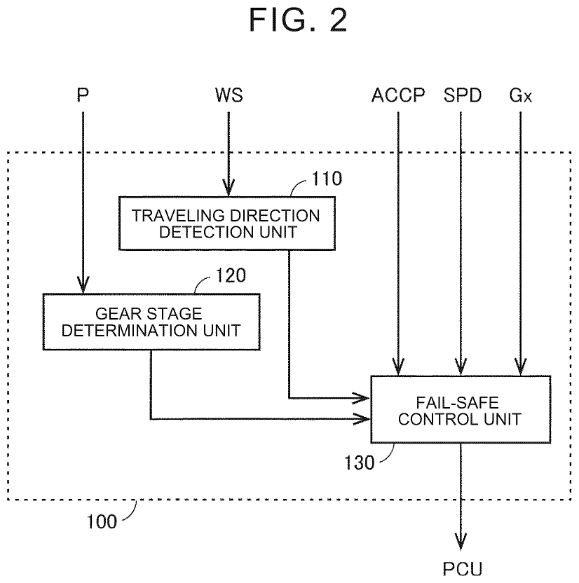

FIG. 2 is a diagram illustrating functional blocks configured in the ECU 100 in the present embodiment. In FIG. 2, a traveling direction detection unit 110 detects the traveling direction of the electrified vehicle V (forward or backward). For example, direction of rotation of the drive wheels 5 is detected based on the wheel speed WS detected by the wheel speed sensor 154, and thereby the traveling direction of the electrified vehicle V is detected. A gear stage determination unit 120 determines whether the gear stage selected by the shift lever is forward gear or reverse gear. For example, whether the gear stage is forward gear or reverse gear is determined from the shift position P detected by the shift position sensor 152.

A fail-safe control unit 130 executes “fail-safe control” that allows reverse rotation of the MG 1. When the traveling direction detected by the traveling direction detection unit 110 is forward, and the gear stage determination unit 120 determines that the gear stage is reverse gear, the fail-safe control unit 130 executes fail-safe control. Also, when the traveling direction detected by the traveling direction detection unit 110 is backward, and the gear stage determination unit 120 determines that the gear stage is forward gear, the fail-safe control unit 130 executes fail-safe control.

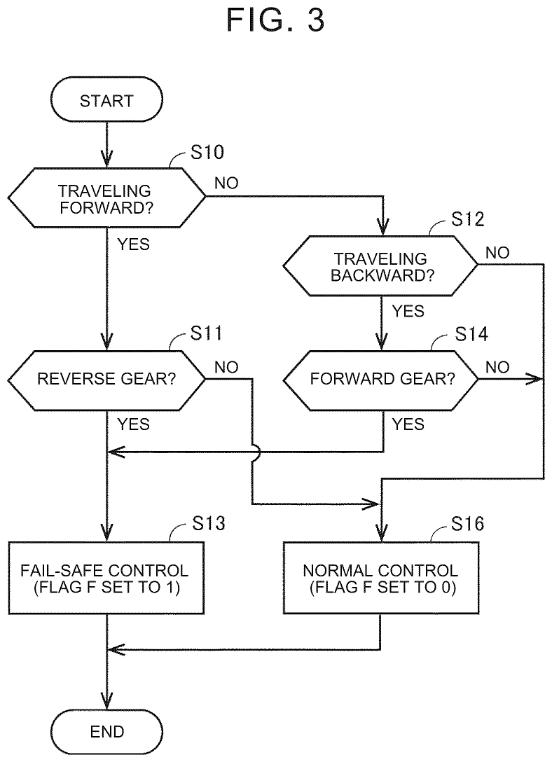

FIG. 3 is a flowchart showing an example of processing executed by the ECU 100 in the present embodiment. The processing of this flowchart is repeatedly executed at predetermined intervals while the electrified vehicle V is activated (from when the power switch is turned on until when the power switch is turned off). In step (hereinafter, “step” will be abbreviated to “S”) 10, determination is made regarding whether the electrified vehicle V is traveling forward. For example, when the wheel speed WS detected by the wheel speed sensor 154 indicates that the wheels are rotating in the forward direction, determination is made that the vehicle is traveling forward (positive determination), and the processing advances to S11. Also, when determination is not made that the vehicle is moving forward (negative determination), the processing advances to S12.

In S11, determination is made regarding whether the gear stage of the transmission 3 is reverse gear. When the transmission 3 is a five-speed manual transmission, the shift position P detected by the shift position sensor 152 outputs a signal indicating one of forward gears “first gear to fifth gear” and reverse gear “R”. In S11, when a signal indicating the shift position P is “R” is received, determination is made that the vehicle is in reverse gear (positive determination), and the processing advances to S13. When the signal does not indicate that the shift position P is “R”, determination is made that the vehicle is not in reverse gear (negative determination), and the processing advances to S16.

In S12, determination is made regarding whether the electrified vehicle V is traveling backward. When the wheel speed WS detected by the wheel speed sensor 154 indicates that the wheels are rotating in the backward direction, determination is made that the vehicle is traveling backward (positive determination), and the processing advances to S14. When determination is not made that the vehicle is traveling backward (negative determination), this means that the electrified vehicle V is stopped, and the processing advances to S16.

In S14, determination is made regarding whether the gear stage of the transmission 3 is forward gear. When a signal is received indicating that the shift position P detected by the shift position sensor 152 is “first gear to fifth gear”, determination is made that the gear is forward gear (positive determination), and the processing advances to S13. When the signal does not indicate that the shift position P is “first gear to fifth gear”, determination is made that the vehicle is not in forward gear (negative determination), and the processing advances to S16.

In S13, fail-safe control is executed. For example, fail-safe control, which will be described later, is executed by setting a flag F to 1. In S16, normal control is executed. For example, normal control is executed by setting the flag F to 0. In normal control, the command torque Tqt of the MG 1 is calculated based on the accelerator operation amount ACCP, the vehicle speed SPD, and so forth, and the PCU 20 is controlled accordingly, as described above. The command torque Tqt is positive torque in normal control.

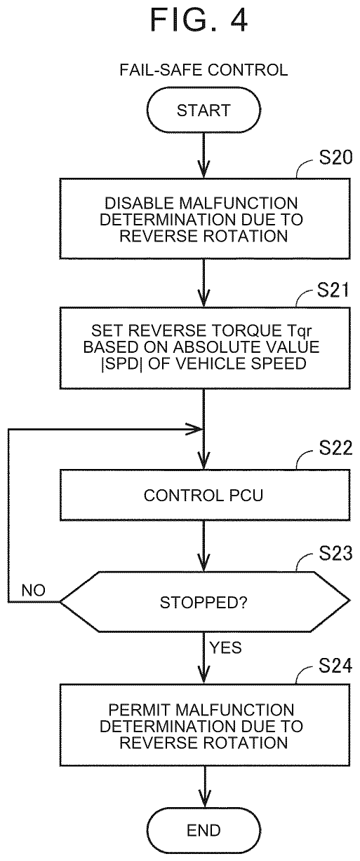

FIG. 4 is a flowchart showing an example of processing for fail-safe control that is executed by the ECU 100. This flowchart is executed when the processing of S13 (FIG. 3) is executed (when the flag F is set to 1).

In FIG. 4, in S20, “malfunction determination”, for determining that the system is malfunctioning when reverse rotation of the MG 1 is detected, is disabled.

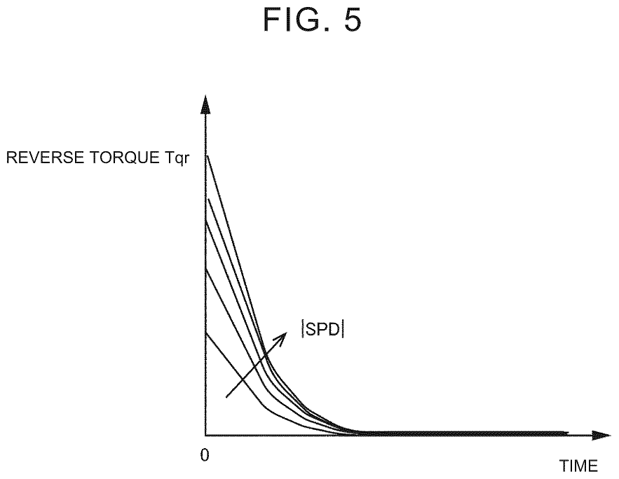

Subsequently, in S21, reverse torque Tqr is calculated based on an absolute value |SPD| of the vehicle speed SPD. FIG. 5 is a map for calculating the reverse torque Tqr. In FIG. 5, the vertical axis represents the magnitude of the reverse torque Tqr, and the horizontal axis represents time. As shown in FIG. 5, the greater the absolute value |SPD| of the vehicle speed SPD is, the greater the initial value of the reverse torque Tqr is, and the initial value of the reverse torque Tqr then decreases to zero over time. The reason why the greater the absolute value |SPD| of the vehicle speed SPD is, the greater the initial value of the reverse torque Tqr is, is as follows. The higher the absolute value |SPD| of the vehicle speed SPD is, the greater the inertial force of the MG 1 in the forward rotation direction is, and accordingly, the inertial force of the MG 1 is canceled out by using a greater reverse torque Tqr. Note that this map is set in advance by experimentation or the like.

In S21, the reverse torque Tqr is calculated from the map in FIG. 5, based on the vehicle speed SPD detected by the vehicle speed sensor 153. Note that the vehicle speed SPD is the vehicle speed SPD detected by the vehicle speed sensor 153 when the processing of S21 is performed (when the flag F is set to 1 and this routine is started).

In the subsequent S22, the PCU 20 is controlled so that the reverse torque Tqr is output from the MG 1. The reverse torque Tqr is a torque that acts in an opposite direction to the forward rotation direction, thereby allowing reverse rotation in which the MG 1 rotates in a direction opposite to the forward rotation direction.

In S23, determination is made regarding whether the electrified vehicle V has stopped. For example, when the wheel speed WS reaches 0, determination is made that the electrified vehicle V has stopped. When the electrified vehicle V is not stopped, a negative determination is made in S23, and the processing advances to S22. In S22, the PCU is controlled so that the reverse torque Tqr is output from the MG 1, and the reverse torque Tqr decreases to zero over time.

When the wheel speed WS reaches 0 and the electrified vehicle V stops, a positive determination is made in S23, and the processing advances to S24. In S24, after permitting “failure determination” for determining that the system is malfunctioning when reverse rotation of the MG 1 is detected, the current processing ends.

According to the present embodiment, when the electrified vehicle V is traveling, the MG 1 is controlled to forward rotation under normal control, so as to travel forward when forward gear of the transmission 3 is achieved, and to travel backward when reverse gear is achieved. Forward/reverse traveling of the electrified vehicle V is performed by operating the gear stage of the transmission 3. When the electrified vehicle V is traveling forward and the transmission 3 is switched to reverse gear, reverse rotation of the MG 1 is allowed by fail-safe control. Allowing reverse rotation of the MG 1 enables the drive wheels to be suppressed from being driven in the backward direction, thereby suppressing a great shock from being generated in the vehicle. When the electrified vehicle V is traveling backward and the transmission 3 is switched to forward gear, reverse rotation of the MG 1 is allowed by fail-safe control. Allowing reverse rotation of the MG 1 enables the drive wheels 5 to be suppressed from being driven in the forward direction, thereby suppressing a great shock from being generated in the vehicle.

Reverse rotation of the MG 1 is allowed until the electrified vehicle V comes to a stop. When the electrified vehicle V stops, fail-safe control ends and normal control starts. Accordingly, the MG 1 is controlled to forward rotation, and traveling corresponding to the gear stage of the transmission 3 is enabled.

In the present embodiment, when the electrified vehicle V is switched to reverse gear while traveling forward, or when the electrified vehicle V is switched to forward gear while traveling backward, the MG 1 is controlled to output the reverse torque Tqr, and the MG 1 outputs torque in the direction of reverse rotation. This reverse torque Tqr can cancel out the inertial force of the MG 1 in the forward rotation direction, and can suppress a great shock from being generated in the vehicle more suitably.

Further, the reverse torque Tqr becomes 0 regardless of the magnitude of the accelerator operation amount ACCP, as shown in the map in FIG. 5. Accordingly, the electrified vehicle V is decelerated toward a stop, regardless of the operation state of the accelerator pedal.

A first modification of the present embodiment will be described. In the above embodiment, reverse rotation of the MG 1 is allowed when the shift lever is switched to reverse gear while the electrified vehicle V is traveling forward, or when the shift lever is switched to forward gear while the electrified vehicle V is traveling backward. The rotation (torque) of the MG 1 is not input to the transmission 3 when the clutch 2 is disengaged, even in a state in which the shift lever is switched to reverse gear or forward gear, and accordingly an arrangement may be made in which reverse rotation of the MG 1 is allowed taking into consideration the state of engagement of the clutch 2.

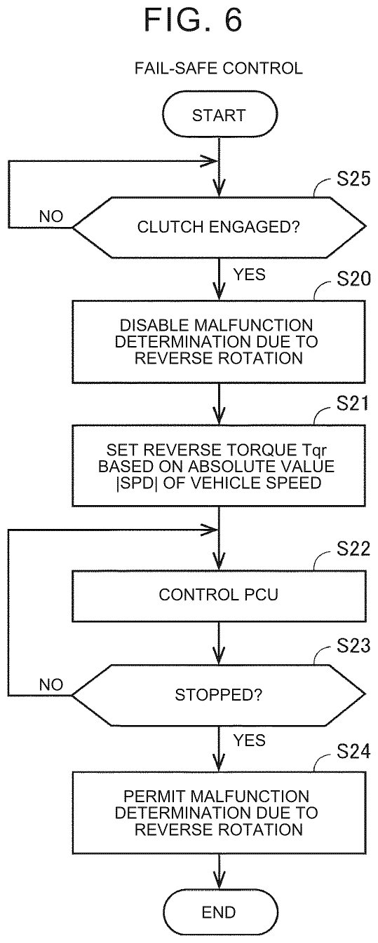

FIG. 6 is a flowchart showing an example of processing for fail-safe control that is executed by the control ECU in the first modification. Processing of S25 is added prior to the processing of S20 to S24 in FIG. 4 in the flowchart in FIG. 6, and the processing of S20 to S24 is the same as the processing of S20 to S24 in FIG. 4.

In the first modification, when fail-safe control is started, determination is made in S25 regarding whether the clutch 2 is in an engaged state. When the clutch 2 is in a disengaged state, a negative determination is made, and the processing of S25 is performed again until the clutch 2 is in an engaged state. When the clutch 2 is in the engaged state, a positive determination is made in S25, and the processing advances to S20. The processing of S20 and thereafter is the same as in FIG. 4, and according description thereof will be omitted.

Effects the same as those of the above-described embodiment can be obtained by the first modification as well. Next, a second modification of the present embodiment will be described. In the above embodiment, in fail-safe control, the reverse torque Tqr is calculated from the map in FIG. 5, based on the absolute value |SPD| of the vehicle speed SPD. In the second modification, the reverse torque Tqr is calculated based on an absolute value |Gx| of longitudinal acceleration Gx of the electrified vehicle V.

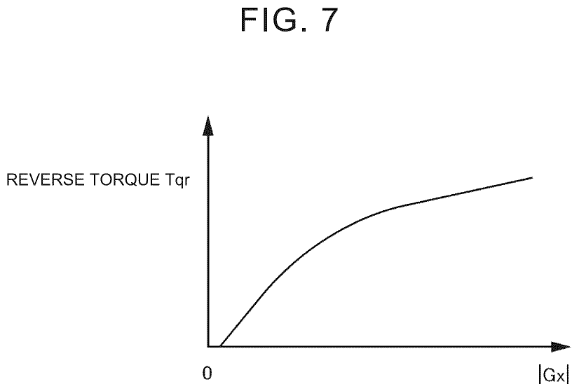

FIG. 7 is a map for calculating reverse torque Tqr in the second modification. In FIG. 7, the vertical axis represents the magnitude of the reverse torque Tqr, and the horizontal axis represents the absolute value |Gx| of the longitudinal acceleration Gx. As shown in FIG. 7, the greater the absolute value |Gx| of the longitudinal acceleration Gx is, the greater a value the reverse torque Tqr is, and the reverse torque Tqr becomes 0 when the absolute value |Gx| becomes small.

In the second modification, the reverse torque Tqr is calculated using the map in FIG. 7 in the processing of S21 (FIGS. 4 and 6). In the second modification the processing advances to S21 even though the processing advances to S22 in the above-described embodiment and the first modification, when a negative determination is made in S23. Each time processing of S21 is performed, the absolute value |Gx| is acquired from the longitudinal acceleration Gx that is detected by the longitudinal acceleration sensor 155, the reverse torque Tqr is calculated from the map in FIG. 7, and the PCU 20 is controlled so that the reverse torque Tqr is output from the MG 1.

The reverse torque Tqr calculated from the map of FIG. 7 can cancel out the inertial force of the MG 1 in the forward rotation direction in this second modification as well, thereby suppressing a great shock from being generated in the vehicle more suitably.

Next, a third modification will be described. In the above embodiment, in fail-safe control, the reverse torque Tqr is calculated from the map in FIG. 5, based on the absolute value |SPD| of the vehicle speed SPD. An arrangement may be made in which the command torque of the MG 1 is set to zero in fail-safe control, without calculating the reverse torque Tqr.

In the third modification, the command torque Tqt of the MG 1 is set to 0 in the processing of S21 (FIGS. 4 and 7). Accordingly, in S22, the PCU 20 is controlled so that the torque output from the MG 1 becomes zero.

Reverse rotation of the MG 1 is allowed when the gear stage is switched to reverse gear while the electrified vehicle V is traveling forward, or when the gear stage is switched to forward gear while the electrified vehicle V is traveling backward, in this third modification as well, and accordingly a great shock can be suppressed from being generated in the vehicle. Also, the electrified vehicle V is decelerated toward a stop.

In the above-described embodiment, an example in which the transmission 3 is a constant-mesh manual transmission has been described. When a planetary gear multi-stage automatic transmission is used as the transmission, determination may be made that the vehicle is in forward gear when drive range (D range) is selected, and determination may be made that the vehicle is in reverse gear when reverse range (R range) is selected. Further, in the planetary gear multi-stage automatic transmission, determination may be made that the vehicle is in forward gear when a friction engagement device for the gear stage that is forward gear begins to engage, and determination may be made that the vehicle is in reverse gear when a friction engagement device for the gear stage that is reverse gear begins to engage. When the transmission is a continuously variable transmission, determination may be made that the vehicle is in forward gear when the forward/reverse switching device is switched to forward, and determination may be made that the vehicle is in reverse gear when the forward/reverse switching device is switched to reverse.

The following aspects can be exemplified as exemplifications of embodiments according to the present disclosure.
1) An electrified vehicle (V) includes a motor (1), a transmission (3) that includes a forward gear and a reverse gear and that transmits output of the motor (1) to drive wheels (5), and an electronic control unit (100), and while the motor (1) is performing forward rotation, the electrified vehicle (V) travels forward when the forward gear is achieved, and travels backward when the reverse gear is achieved. The electronic control unit (100) performs control (S16) so that the motor (1) performs forward rotation when the electrified vehicle (V) is traveling, and allows reverse rotation in which the motor (1) rotates in an opposite direction from the forward rotation when the transmission (3) is switched to reverse gear while the electrified vehicle (V) is traveling forward, and allows reverse rotation of the motor (1) when the transmission (3) is switched to forward gear while the electrified vehicle (V) is traveling backward (S13).
2) In 1 above, the electronic control unit (100) allows the motor (1) to perform reverse rotation, regardless of the operation of the accelerator pedal, until the electrified vehicle (V) stops.
3) In the above 1 or 2, the electronic control unit (100) disables malfunction determination for performing malfunction determination when reverse rotation of the motor (1) is detected, as long as reverse rotation of the motor (1) is allowed.

The embodiment disclosed herein should be considered as exemplary and not restrictive in all respects. The scope of the present disclosure is shown by the claims and not by the above description of the embodiment and is intended to include all modifications within the meaning and scope equivalent to those of the claims.

What is claimed is:

1. An electrified vehicle, comprising:
a motor;
a transmission that includes a forward gear and a reverse gear, and that is configured to transmit output of the motor to drive wheels; and
an electronic control unit;
wherein the electronic control unit is configured to, while the motor is performing forward rotation, cause the electrified vehicle to travel forward when the forward gear is achieved, and to cause the electrified vehicle to travel backward when the reverse gear is achieved,
wherein the electronic control unit is configured to, when the electrified vehicle is traveling, control the motor to perform forward rotation, and
wherein the electronic control unit is configured to allow reverse rotation in which the motor rotates in an opposite direction from the forward rotation, when the transmission is switched to the reverse gear while the electrified vehicle is traveling forward, and is configured to allow the reverse rotation of the motor when the transmission is switched to the forward gear while the electrified vehicle is traveling backward.

2. The electrified vehicle according to claim 1, wherein the electronic control unit is configured to allow the reverse rotation of the motor until the electrified vehicle comes to a stop.

3. The electrified vehicle according to claim 1, wherein the electronic control unit is configured to perform control in which torque in a direction of reverse rotation is output from the motor when allowing the reverse rotation of the motor.

4. The electrified vehicle according to claim 1, wherein the electronic control unit is configured to allow the reverse rotation of the motor by setting output torque of the motor to zero.

5. A control method of an electrified vehicle including a motor and a transmission that includes a forward gear and a reverse gear and that is configured to transmit output of the motor to drive wheels, the control method comprising:
causing the electrified vehicle to travel forward when the forward gear is achieved, and causing the electrified vehicle to travel backward when the reverse gear is achieved, while the motor is performing forward rotation;
controlling the motor to perform forward rotation when the electrified vehicle is traveling; and
allowing reverse rotation in which the motor rotates in an opposite direction from the forward rotation, when the transmission is switched to the reverse gear while the electrified vehicle is traveling forward, and allowing the reverse rotation of the motor when the transmission is switched to the forward gear while the electrified vehicle is traveling backward.
